(19) United States
(12) Patent Application Publication
(10) Pub. No.: US 2004/0146629 A1
(43) Pub. Date: Jul. 29, 2004

(54) Pasta composition and method of making it

(75) Inventor: Francis Ford Coppola, San Francisco, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: The Coppola Companies

(21) Appl. No.: 10/726,158

(22) Filed: Dec. 2, 2003

Related U.S. Application Data
(60) Provisional application No. 60/430,568, filed on Dec. 3, 2002.

(51) Int. Cl. A23L 1/20

(52) U.S. Cl. 426/634

(57) ABSTRACT

The present invention generally relates to a pasta product, and the method for making the pasta product. More specifically, this invention provides a method for making a tofu-based pasta. The tofu-based pasta retains the flavor of conventional gnocchi and pasta, as well as, fresh gnocchi and pasta.

### REFERENCE TO RELATED APPLICATION

This application claims the benefit of U.S. Provisional Application, Serial No. 60/430,568, filed Dec. 3, 2002, which is incorporated by reference.

### BACKGROUND OF THE INVENTION

1. Field of the Invention

The present invention generally relates to a tofu-based pasta product and a method for making it. The tofu-based pasta retains the flavor of conventional gnocchi or pasta, as well as, fresh gnocchi or pasta.

2. Background of the Related Art

The demand for nutritious and simple food options increases with the general public's nutritional knowledge and time pressures. A common choice amongst people for fulfilling this demand is pasta. Pasta provides complex carbohydrates and helps satisfy recommended dietary iron intake. Moreover, pasta is naturally low in fat as well as cholesterol and sodium. Pasta is also popular because of the many meal options it provides and its good taste. However, pasta's greatest nutritional shortcoming is that is has a very low protein content.

There are numerous types of pastas prepared from wheat-based flour. These include spaghetti, penne, linguini, ziti, and basically any type of noodle. Pastas may also be egg based, and even potato-based as in the case with gnocchi. Attempts at increasing the nutritional value of pasta by adding vegetables to the dough have been disclosed, as has adding soy protein to the pasta dough. U.S. Pat. No. 4,466,985 of Tsen et al. discloses a method for preparing a canned, retorted pasta, where the pasta is composed of wheat-derived material (i.e., flour), water and soy protein. U.S. Pat. No. 4,857,357 of Ammann et al. discloses a process for preparing soya food products. In the '357 patent, soybeans and water are combined to form a paste, which is shaped and dried and can be consumed as noodles or as a butter substitute. U.S. Pat. No. 5,087,470 of Anand discloses a legume-based pasta and its method of preparation.

### SUMMARY OF THE INVENTION

Tofu, or soybean curd, is a good source of high quality protein that comes from soybeans. Tofu also provides iron and B-vitamins and is low in sodium. The inventor has recognized that the use of tofu in pasta can resolve some of pasta's inherent nutritional shortcomings.

Accordingly, this invention provides a pasta and gnocchi product that has the same taste as conventional or fresh pasta and gnocchi. The invention increases the nutritional value of pasta. The invention also provides a low carbohydrate, high protein pasta product. The invention also provides methods of making a tofu-based pasta.

This invention comprises a tofu-based pasta product, comprising tofu, mashed potatoes, egg whites, flour, salt, and baking soda.

In one preferred embodiment the invention comprises a high quality tofu-based product, comprising per unit batch approximately 14 ounces tofu, 3.0 tablespoons mashed potatoes, 6.0 teaspoons of egg whites, 0.75 Cups flour, 0.5 teaspoons salt, and 0.5 teaspoons baking soda. All amounts presented herein are ±20% of the given value (e.g., 14±2.8 ounces of firm tofu, etc.).

This invention also comprises a method of making a tofu-based pasta product. The method first comprises removal of water from the tofu. Then the tofu is mixed with mashed potatoes, salt, baking soda, and egg whites. After the ingredients are sufficiently mixed to form a tofu-based dough, flour is blended with the dough to decrease the dough's moistness. Finally, the dough is formed into a pasta shape and cooked in boiling water. The method of this invention is suitable for making a variety of different pasta products. These include, for example, cavellelli, orecchi, and gnocchi.

In addition, this invention comprises a method of making a tofu-based pita bread product and a tofu-based tortilla and tamale product.

### DETAILED DESCRIPTION

In general, the ingredients used in this invention are preferably of high quality. Although many of the ingredients are familiar to those skilled in the art, this invention's combination of ingredients provides a unique tofu-based pasta product.

1. Ingredients

This invention combines the following ingredients to make an unique tofu-based pasta product. The proportion of ingredients used varies depending on the amount of pasta to be produced, the type of pasta to be made, the mixing conditions, and the like.

Tofu

This invention's pasta product primarily comprises tofu. There are four types of tofu, firm, extra firm, soft and silken. Firm tofu is dense and solid and is the most versatile. It also has a higher protein, fat, and calcium content than the other forms. This invention preferably uses a low calorie firm tofu for making the pasta because of its texture and consistency. Soft tofu is typically used in soups because it can be easily blended. Silken tofu is like a creamy custard and is used in blended and pureed dishes. These other types of tofu are not suitable for pastas because of their texture, which is too smooth. The tofu-based pasta product preferably uses approximately 14 ounces of firm tofu per unit batch.

Mashed Potatoes

Another ingredient in this invention is mashed potato. In general mashed potatoes can be prepared by standard, art-recognized methods, e.g., by boiling potatoes and then whipping them with milk, butter, and optionally other flavor components. The potatoes may be instant potatoes or fresh potatoes of the russet, red, or like varieties. Preferred potatoes for mashed potatoes are russet, which are higher in starch content, with a dry, mealy texture. Moreover, they tend to be long and have a coarse skin. There are several options for the milk component of mashed potatoes as well, including whole, skim, instant, dried, cream, 1% milk and 2% milk. A few examples of flavor components include salt, garlic, cheese, and pepper. The use of a prepared mashed potato made from baked potatoes rather than boiled potatoes is preferred to decrease moisture content so that the dough's texture is dry. Placing the mashed potatoes between two paper towels, for example, and then pressing out any moisture may be done to ensure that the mashed potatoes are suitably dry. The unit batch of tofu-based pasta product preferably uses approximately 3 tablespoons of baked russet mashed potatoes.

Salt

Salt is also used in this invention. Salt is used to enhance the flavor of this invention's pasta product. Salt is a common food additive because it brings out the natural flavors of foods, improves texture, and serves as an effective preservative. The tofu-based pasta product preferably uses approximately 0.5 teaspoons of salt per unit batch, although the tofu-based pasta product of the invention may be made without salt, such as to meet the needs of those who may be on a restricted salt diet.

Baking Soda

Another ingredient in this invention is baking soda (sodium carbonate). Baking Soda is used to promote leavening, which increases the surface area of dough or batter by causing it to rise and become light and porous. The tofu-based pasta product preferably uses approximately 0.5 teaspoons of baking soda per unit batch.

Egg Whites

Egg whites are used as an ingredient in this invention's pasta formulation. Whole eggs are not suitable. Egg whites from whole eggs or dehydrated egg whites can be used. The tofu-based pasta product preferably uses approximately 6 teaspoons of egg white per unit batch.

Flour

Flour is also an ingredient for this invention's pasta. There are several different types of flour, such as semolina, durum flour, farina and all-purpose flour. Any type of flour may be used in the past of the invention. The tofu-based pasta product preferably uses approximately 0.75 Cups of flour per unit batch.

A unit batch is defined as: 14 ounces firm Tofu, 0.5 teaspoons salt, 0.5 teaspoons baking soda, 6.0 teaspoons egg white, 3 tablespoons mashed potatoes, and 0.75 Cup flour.

2. Method of Preparation

Combining the above essential ingredients in the appropriate amounts will result in the desired pasta product. The method of making the pasta product comprises:

(1) removing water from tofu;

(2) mixing the tofu from (1) with mashed potatoes, egg whites, salt and baking soda to form a dough;

(3) blending the dough with a sufficient amount of flour;

(4) forming the dough into a pasta shape; and

(5) cooking the dough in the desired pasta shape.

Removing Water from Tofu

Any suitable technique for removing water from the tofu can be used. These include, first, use of a cheesecloth to remove the water from the tofu. More specifically, the tofu is placed into cheesecloth and then drained in a colander, force is applied, as necessary, to press out the water from the tofu. A second technique involves use of a centrifuge to remove the water from the tofu. A third technique involves placing the tofu into a refrigerator overnight, and allowing it to drain while in the refrigerator. The objective of this step is to remove as much water from the tofu as reasonably possible so that after adding the remaining ingredients the dough is not moist. More specifically, removing the water from the tofu should preferably decrease the tofu's weight by approximately 37%.

Mixing the Ingredients to Form Dough

Prior to adding flour, the ingredients are mixed together in proportions depending on the resulting flavor and texture of the pasta product. The ingredients may be mixed using a food processor. The ingredients are mixed until a smooth dough is formed.

Blending the Pasta Dough With Flour

After the ingredients are thoroughly mixed to form the dough, the flour may be added. Generally, the flour is blended into the dough in proportions depending on the resulting texture of the pasta product. For example, if the dough has a higher moisture content, then more flour must be added to the dough to lower the moisture. It is a routine matter for those skilled in the art to determine the appropriate amount of flour. As an example, half of the flour can be added to the above mixed ingredients and the mixture then blended in a food processor until the dough is smooth. The dough then can be removed from the food processor and placed onto a flat work surface. Next, the remaining flour can be added gradually to the dough until a non-sticky dough results. The resulting non-sticky dough should be workable on a dough board or through a pasta machine for forming the shape of the pasta product.

Forming the Dough into a Pasta Shape

Prior to cooking the dough, the properly mixed and blended pasta dough is formed into the desired pasta shape. The pasta may be formed into a wide variety of shapes, including but not limited to, gnocchi, cavellelli, or orecchi. Extrusion of the tofu-based pasta dough may also be used for shaping the dough, in which the size and shape of the extrusion determines the pasta's shape. Flour can be used in forming the dough to reduce its stickiness in shaping the pasta.

In addition, the tofu-based dough may be used in making pita bread, as well as, other bread type products. The method of preparing a tofu-based pita bread product further comprises placing the dough on a working surface, adding a sufficient amount of flour to the dough to reduce stickiness, rolling the dough flat, and then cutting the flat dough into small discs. The discs can have a diameter of 1.0 to 1.5 inches. The pita bread product can be cooked by placing the small discs of dough onto an oiled pan, and baking the discs in an oven at 325° C. until the discs turn golden-brown in color. Egg whites may be brushed onto the small discs of dough to enhance the golden-brown color of the pita bread products. The tofu-based pita bread products may be used as a bread or cracker.

This method may be used also to produce tofu-based tortillas or tamales. However, in that instance cornmeal should be substituted for flour. Preferably, Masa-instant dry type of cornmeal is used for making the tamales or tortillas.

Cooking the Dough

After the tofu-based pasta dough is formed into the proper shape it is cooked as one would cook corresponding standard, prior art pastas. The pasta is preferrably cooked by boiling the dough in water. The boiling water should preferably contain salt. The dough is boiled for 5 to 6 minutes, depending on when the dough shapes rise to the boiling water's surface. The dough is finished cooking upon its rising to the surface. After the dough is cooked, the tofu-based pasta product is finished and ready to be eaten or packaged. An alternative manner for cooking the dough is baking the dough at 350° F. for approximately thirty minutes.

The invention and method of making it are now described in such full, clear, concise and exact terms as to enable any person skilled in the art to which it pertains, to make the same. It is to be understood that the foregoing describes preferred embodiments of the present invention and that modifications may be made therein without departing from the spirit or scope of the invention as set forth in the claims.

I claim:

1. A tofu-based pasta comprising:
(a) tofu;
(b) mashed potatoes;
(c) salt;
(d) baking soda;
(e) egg whites; and
(f) flour.

2. The pasta of claim 1 wherein the tofu is low calorie and firm.

3. The pasta of claim 1 wherein the mashed potatoes are made from baked potatoes.

4. The pasta of claim 1 wherein ingredients (a)-(f) are present in the following amounts by ±20%, per unit batch:
(a) 14 ounces tofu;
(b) 3 tablespoons mashed potatoes;
(c) 0.5 teaspoons salt;
(d) 0.5 teaspoons baking soda;
(e) 6.0 teaspoons egg whites; and
(f) 0.75 Cups flour.

5. A method of making a pasta product comprising:
(a) removing water from tofu;
(b) mixing the tofu with mashed potatoes, egg whites, salt and baking soda to form a dough;
(c) blending the dough with a sufficient amount of flour to produce a non-sticky dough ; and
(d) forming the dough into a pasta shape.

6. The method of claim 5 further comprising cooking the pasta shaped dough.

7. The method of claim 5, wherein the removing water from the tofu step is done by using a cheesecloth and draining.

8. The method of claim 5, wherein the removing water from the tofu step is done by use of a centrifuge.

9. The method of claim 5, wherein the removing water from the tofu step is done by refrigerating and draining the tofu.

10. The method of claim 6, wherein the cooking step is conducted by boiling or baking.

11. The method of claim 10, wherein the boiling of the dough lasts for 5 to 6 minutes.

12. The method of claim 10, wherein the baking of the dough is done in an oven at 350° F. for approximately thirty minutes.

13. A pasta product prepared according to the process of claim 5.

14. The pasta of claim 13, wherein the pasta product is gnocchi, cavellelli, orecchi, or any other pasta type.

15. A method of making a pita bread product comprising:
(a) removing water from tofu;
(b) mixing the tofu with mashed potatoes, egg whites, salt and baking soda to form a dough;
(c) blending the dough with a sufficient amount of flour to produce a non-sticky dough; and
(d) forming the dough into small discs.

16. The method of claim 15 further comprising cooking the disc-shaped dough.

17. The method of claim 16, wherein the cooking step comprises placing the small discs of dough onto a pan, brushing egg white onto the small balls of dough, and baking the small balls in the oven.

18. The method of claim 17, wherein the pan is oiled.

19. The method of claim 17, wherein the oven is set to 325° C.

20. The method of claim 17, wherein the small discs of dough are baked in the oven until they turn a golden brown color.

21. The method of claim 15, wherein the forming step comprises placing the dough onto a working surface, adding a suitable amount of flour to the dough, rolling the dough flat, and cutting the dough into small disks.

22. The method of claim 21, wherein the small discs have a diameter in the range of 1 to 1.5 inches.

23. A pita bread product prepared according to the process of claim 15.

24. The pita bread of claim 23, wherein the product is a bread or a cracker.

25. A method of making a tamale product comprising:
(a) removing water from tofu;
(b) mixing the tofu with mashed potatoes, egg whites, salt and baking soda to form a dough;
(c) blending the dough with a sufficient amount of cornmeal to produce a non-sticky dough ;and
(d) forming the dough.

26. The method of claim 25, wherein the cornmeal is Masa Instant dry.
